(19) United States
(12) Patent Application Publication
(10) Pub. No.: US 2008/0214078 A1
(43) Pub. Date: Sep. 4, 2008

(54) Creep Resistant Adhesives and Tapes Make Therewith

(76) Inventors: Ben Vanmarcke, Antwerpen (BE); Jos Willekens, Hoogstraten (BE)

Correspondence Address: RENNER, OTTO, BOISSELLE & SKLAR, LLP (AVERY), 1621 EUCLID AVE, 19TH FL, CLEVELAND, OH, 44115-2191, US

(21) Appl. No.: 11/911,257

(22) PCT Filed: Apr. 14, 2006
(86) PCT No.: PCT/US06/14296

§ 371 Date: Oct. 11, 2007

Related U.S. Application Data
(60) Provisional application No. 60/673,057, filed on Apr. 20, 2005.

(51) Int. Cl. C09J 7/02

(52) U.S. Cl. 442/151

(57) ABSTRACT

The invention relates to adhesive compositions comprising from 20% to 60% by weight of an elastomeric component comprising a block copolymer having a thermoplastic block portion of a vinyl-substituted aromatichydrocarbon and an elastomeric block portion of a conjugated diene, at least 20% of a solid tackifying resin having a Ring & Ball softening point of at least 115° C. or a glass transition temperature of at least 70° C., and from 5% to 30% of a liquid tackifying resin. The invention further relates to adhesive tapes having the pressure sensitive adhesive composition thereon.

### TECHNICAL FIELD OF THE INVENTION

The invention relates to pressure sensitive adhesive compositions and, more particularly, pressure sensitive adhesive compositions that exhibit improved creep resistance. The invention further relates to pressure sensitive adhesive tapes using the pressure sensitive adhesive compositions.

### BACKGROUND OF THE INVENTION

Pressure sensitive adhesives (PSAs) are viscoelastic-elastomeric materials that can adhere strongly to a variety of substrates upon application of light contact pressure and short contact time. PSA applications range from various tape and label products used for industrial, medical and consumer markets. In these applications, PSAs are normally coated onto face or backing materials at 15-100 μm dry film thickness. Typical face stock materials include paper, film, foil, woven and nonwoven materials.

Polymers used in making PSAs are primarily divided into styrenic block copolymer (SBC) and acrylic. SBCs are mainly used for paper label and oriented polypropylene (OPP) tapes due to their highly aggressive tack and moderate shear holding power. SBCs exist in a two phase morphology, the first a hard polystyrene domain residing in the second, a conjugated diene rubber matrix. This morphology allows the SBC to be compounded with a high loading of hydrocarbon tackifiers to increase tack without significantly reducing shear.

The prior art is replete with the use of block copolymers in adhesive compositions which include the elastomer and a tackifying resin. As development of these elastomer based compositions has progressed, it has been found that their physical properties, such as tack, ultimate adhesion, peel strength, and creep resistance, are extremely sensitive to the particular elastomer or elastomers used, and the proportion and type of modifiers, such as solid or liquid tackifiers, aromatic or aliphatic tackifiers, plasticizers, extender oils, curing agents and the like.

Physical properties such as tack, peel strength and creep resistance are particularly important in specific applications where the adhesive composition is applied onto a film or nonwoven, such as tab closure used for a disposable diaper or adult incontinent product. In these types of applications, the creep performance or “holding power” of the adhesive is critical so that the adhesive tabs do not debond from the film or nonwoven.

The use of tackifying resins is known to provide specific adhesion and to modify peel values. Commonly used tackifying resins include those which are rosin derived including rosin acid and rosin ester resins, petroleum derived hydrocarbon resins and terpene based resins. These resins may be modified further to add functionality or aromaticity through the addition of phenolic groups or styrene groups, for instance.

PSAs formulated with previously utilized tackifying resins, however, have utilized increased amounts of rubber-based elastomer material, e.g., at least 50% by weight. Such formulations result in processing difficulties due to increased viscosity. Therefore, it is desirable to provide adhesive compositions having ease of manufacture and which exhibit improved creep resistance, good tack and high peel, especially onto nonwoven materials, such as are used in typical diaper constructions.

### SUMMARY OF THE INVENTION

In one embodiment, the invention is directed to a pressure sensitive adhesive composition comprising from about 20% to about 60% by weight of an elastomeric component comprising a block copolymer having a thermoplastic block portion of a vinyl-substituted aromatic hydrocarbon and an elastomeric block portion of a conjugated diene; at least about 20% of a solid tackifying resin having a Ring & Ball softening point of at least 115° C. or a glass transition temperature of at least 70° C.; and from about 5% to about 30% of a liquid tackifying resin.

In another embodiment, the invention is directed to a pressure sensitive adhesive tape construction comprising a substrate; and an adhesive composition coated on the substrate, the adhesive composition comprising from about 20% to about 60% by weight of a block copolymer; at least about 20% of a solid tackifying resin having a Ring & Ball softening point of at least about 115° C. or a glass transition temperature of at least about 70° C.; and from about 5% to about 30% of a liquid tackifying resin.

In a further embodiment, the invention is directed to a pressure sensitive adhesive composition comprising from about 33% to about 43% by weight block copolymer; from about 37% to about 57% of a solid tackifying resin; from about 10% to about 20% of a liquid tackifying resin; and less than about 1% antioxidant; wherein the solid tackifying resin comprises a hydrocarbon resin having a Ring and Ball softening point of at least about 115° C. or a glass transition temperature of at least about 70° C.

### DESCRIPTION OF THE INVENTION

The polymers used in formulating the pressure sensitive adhesive compositions of the invention are based upon, but not limited to, as a major component, synthetic elastomeric polymers. In one embodiment, the pressure sensitive adhesive composition of the present invention comprises rubber based elastomer materials such as linear, branched, graft or radial block copolymers represented by the diblock structures A-B, the triblock A-B-A, the radial or coupled structures (A-B)ₙ, and combinations of these where A represents a hard thermoplastic portion or block which is non-rubbery or glassy or crystalline at room temperature but fluid at higher temperatures, and B represents a soft portion or block which is rubbery or elastomeric at service or room temperature. These thermoplastic elastomers may comprise from about 60% to about 85% by weight of rubbery segments and from about 15% to about 40% by weight of non-rubbery segments.

The non-rubbery segments or hard blocks comprise polymers of mono- and polycyclic aromatic hydrocarbons, and more particularly vinyl-substituted aromatic hydrocarbons which may be monocyclic or bicyclic in nature. The preferred rubbery blocks or segments are polymer blocks of homopolymers or copolymers of aliphatic conjugated dienes. Rubbery materials such as polyisoprene, polybutadiene, combinations thereof, and hydrogenated versions thereof, may be used to form the rubbery block or segment. Particularly preferred rubbery segments include polyisoprenes.

The block copolymers of vinyl aromatic hydrocarbons and conjugated dienes which may be utilized include any of those which exhibit elastomeric properties. The block copolymers may be diblock, triblock, multiblock, starblock, polyblock or graftblock copolymers. Throughout this specification and claims, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)_{0,1,2,}-BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As is well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes which may be utilized to prepare the polymers and copolymers are those containing from 2 to about 6 carbon atoms and more generally, from 4 to 5 carbon atoms. Examples include 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used. In one embodiment, the conjugated dienes can be isoprene and 1,3-butadiene and hydrogenated versions thereof.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc. In one embodiment, the vinyl aromatic hydrocarbon can be styrene.

Many of the above-described copolymers of conjugated dienes and vinyl aromatic compounds are commercially available. The number average molecular weight of the block copolymers, prior to hydrogenation, is in one embodiment from about 10,000 to about 600,000, and in one embodiment from about 50,000 to about 250,000.

The average molecular weights of the individual blocks within the copolymers may vary within certain limits. In most instances, the vinyl aromatic block will have a number average molecular weight in the order of about 2000 to about 125,000, and in one embodiment from between about 4000 and 60,000. The conjugated diene blocks either before or after hydrogenation will have number average molecular weights in the order of about 10,000 to about 450,000 and in one embodiment from about 35,000 to 150,000.

Specific examples of diblock and triblock polymers include styrene-butadiene (SB) including Finaprene 1205 available from Total Petrochemical Elastomers, and styrene-isoprene-styrene (SIS) such as Vector 4111 available from Dexco of Houston, Tex. Examples of commercially available block copolymers useful in the adhesives of the present invention also include those available from Kraton Polymers under the tradename Kraton MD6455, a styrene-isoprene-butadiene-styrene (SIBS) having 19% styrene, and Kraton 1118 SBS having 31% styrene and 78% diblock.

Upon hydrogenation of the SBS copolymers comprising a rubbery segment of a mixture of 1,4 and 1,2 isomers, a styrene-ethylene-butylene styrene (SEBS) block copolymer is obtained. A number of selectively hydrogenated block copolymers are available commercially from Kraton Polymers under the general trade designation “Kraton G.” One example is Kraton G1652 which is a hydrogenated SBS triblock comprising about 30% by weight of styrene end blocks and a midblock which is a copolymer of ethylene and 1-butene (EB). A lower molecular weight version of G1652 is available from Kraton Polymers under the designation Kraton G1650. Kraton G1651 is another SEBS block copolymer which contains about 33% by weight of styrene. Kraton G1657 is an SEBS diblock copolymer which contains about 13% by weight styrene. This styrene content is lower than the styrene content in Kraton G1650 and Kraton G1652

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference. Such hydrogenation of the block copolymers which are carried out in a manner and to extent as to produce selectively hydrogenated copolymers having a residual unsaturation content in the polydiene block of from about 0.5% to about 20% of their original unsaturation content prior to hydrogenation.

The pressure-sensitive adhesive compositions generally comprise in one embodiment from about 20% to about 60% by weight of the total composition of an elastomeric component. In one embodiment, the elastomeric component comprises from about 33% to about 43% by weight of the total composition.

As mentioned above, in one embodiment, the adhesive compositions comprise thermoplastic elastomers comprising at least one thermoplastic elastomeric block copolymer which include linear, branched, graft or radial block copolymers. In addition, in one embodiment, the elastomer(s) is (are) tackified with a tackifying component or system. The adhesive composition may contain a blend of one or more of a first solid tackifying resin and one or more of a second liquid tackifying resin. A solid tackifier as used herein is one which is normally solid at or near room temperature and having a Ring & Ball softening point above 115° C. or a glass transition temperature (T_{g}) of at least 70° C.

The solid tackifying resin component includes those aliphatic hydrocarbon resins made from the polymerization of a feed stream consisting mainly of unsaturated species containing 5 to 9 carbon atoms; mixed aliphatic/aromatic tackifying resins; and hydrogenated tackifying resins. The hydrogenated resins can include resins made from the polymerization and subsequent hydrogenation of a feedstock consisting mainly of dicyclopentadiene; resins produced from the polymerization and subsequent hydrogenation of pure aromatic feedstocks such as styrene, alpha-methyl styrene, vinyl toluene; resins fashioned from the polymerization and subsequent hydrogenation of an unsaturated aromatic feedstream wherein the feedstream mainly contains species having from 5 to 9 carbon atoms; and hydrogenated aliphatic and aliphatic/aromatic resins.

The solid tackifier component, in one embodiment, will be present in an amount from at least about 25% to about 60% by weight of the adhesive. In one embodiment, the solid tackifier will be present in an amount from about 37% to about 57% by weight of the adhesive. The solid tackifier reduces the modulus of the mixture sufficiently to build tack or adhesion and increase creep resistance.

A variety of useful solid tackifier resins are available commercially including petroleum hydrocarbons resins such as the resins sold under the tradename Regalite by Eastman Chemical Company. One particular example of a useful solid tackifier is Regalite S7125 which is a partially hydrogenated C₉ synthetic tackifier having an Mw of 1240 and having a Ring and Ball softening point of 123° C. Another useful solid tackifier is Regalite R1125, identified as a fully hydrogenated hydrocarbon resin having an Mw of 1300 and a softening point of 123° C. Escorez 1401 (non-hydrogenated) and Escorez 5415 (fully hydrogenated) are solid tackifiers available from ExxonMobil Chemical, and having softening points of 117° C. and 118° C., respectively.

In one embodiment, the solid tackifier component may include a mixture of a solid tackifier having a softening point of at least 115° C. or a T_{g} of at least 70° C. and a solid tackifying resin having a Ring and Ball softening point of from about 75° C. to about 100° C. Such a useful solid tackifier is Regalite R1100 which is a fully hydrogenated hydrocarbon resin having a Ring and Ball softening point of 100° C. In such case, the solid tackifier component having a softening point of at least 115° C. will be present in an amount from at least about 20% by weight of the adhesive.

In one embodiment, the adhesive compositions also may include one or more liquid tackifier resins such as Regalite R1010 or Piccotac 1020-E, both from Eastman Chemical Co, and are low molecular weight hydrocarbon resins. Also useful are the Wingtack® family of resins from Goodyear Tire and Rubber Company (Akron, Ohio) such as Wingtack 10, a normally liquid resin at room temperature having a softening point of 10° C. The amount of the liquid tackifier included in the adhesive compositions may range from about 5% to about 30% by weight based on the weight of the adhesive. In another embodiment, from about 10% to about 20% by weight of the liquid tackifier is included in the adhesive formulations.

The adhesive compositions also may include other materials such as antioxidants, heat and light stabilizers, ultraviolet light absorbers, viscosity modifiers, fillers, colorants, waxes, antiblocking agents, reinforcing agents, processing aids, mineral oil, etc. Hindered phenolic and amine antioxidant compounds may be included in the adhesive compositions, and a wide variety of such antioxidant compounds are known in the art. The amount of antioxidant can be varied, and in one embodiment from about 0.1 to about 3% by weight or more, based on the total weight of the adhesive, is used. A variety of antioxidants are available from Ciba-Geigy under the general trade designations “Irganox” and “Irgafos”. For example, the hindered phenolic antioxidant n-octadecyl 3-(3,5-di-t-butyl-4-hydroxyphenol)-proprionate is available under the general trade designation “Irganox 1076”. Irganox 1010, is identified as Tetrakis (methylene 3-(3′,5′-di-tert-butyl-4′-hydroxyphenol)proprionate) methane. Irgafos 168 is another useful antioxidant from Ciba-Geigy.

The adhesive compositions may be hot melt or solvent based, and may be prepared in a conventional manner by means known to those skilled in the art. The elastomers, tackifiers, antioxidants, and other components are blended together in a mixer (e.g., z-blade mixer) at elevated temperature, preferably in an inert atmosphere, at a residence time of up to 150 minutes.

In one embodiment, an adhesive tape construction is formed by placing the adhesive compositions described above on a substrate. The substrates to which the adhesive compositions of the invention can be applied include paper, vinyl, polymer films, such as polyolefin, polyester, polyvinyl chloride, polyvinyl fluoride (PVF), polyvinylidene difluoride (PVDF), polyethylene terephthalate (PET), etc., and combinations thereof, non-woven fabrics, clay coated paper, glassine, polymer coated paper, paperboard, tissue, etc.

The adhesive compositions of the present invention may be applied to the desired substrate as a coating by any conventional technique known in the coating art such as roller coating, curtain coating, spray coating, die coating, dipping, etc.

The coating weight of the adhesive compositions on the substrate is generally in the range of about 15 to about 100 grams per square meter (gsm), and in one embodiment from about 20 to about 50 gsm, and in one embodiment from about 30 to about 40 gsm.

The following examples illustrate specific pressure sensitive adhesive formulations which are useful in preparing the adhesive compositions. Unless otherwise indicated in the following examples, in the claims, and elsewhere in the written description, all parts and percentages are by weight, and temperatures are in degrees centigrade.

### EXAMPLE 1

Creep resistance is used to evaluate an adhesive's ability to withstand the stress imparted on the adhesive-nonwoven bond when held in a stressed state at the use temperature of the nonwoven article.

Adhesive compositions having the formulations indicated below were prepared, with Sample A being in accordance with the present invention and Sample B serving as a comparative example:

TABLE 1

| Component | Sample A | Sample B |
|---|---|---|
| Escorez 5415 | 44.6 | — |
| Irganox B612 | 0.74 | 0.74 |
| Vector 4111A | 39.7 | 39.7 |
| Regalite R1100 | | 44.6 |
| Regalite S7215 | — | — |
| Kraton MD6455 | — | — |
| Piccotac 1020-E | 14.9 | 14.9 |

Adhesive tape samples were prepared by coating the adhesives listed in Table 1 onto cast polypropylene films at a coat weight of 40 g/m². The tapes were then laminated onto a nonwoven backsheet to create a sample measuring 25 mm×25 mm. The nonwoven backsheet was then clamped into an oven at 37° C. and a 0.5 kg weight attached to the tape. The time was recorded until tape and nonwoven substrate delaminated. The tack, as measured by PSTC5, and time for delamination of each adhesive tape from the nonwoven substrate is depicted in Table II:

TABLE II

| | Time for Delamination | |
|---|---|---|
| Sample | (minutes) | Tack (N/25 mm) |
| A | 10,000 | 37.0 |
| B | 1,300 | 35.0 |

### EXAMPLE 2

Adhesive compositions having the formulations below in Table III were prepared in accordance with the present invention:

TABLE III

| Component | Sample C | Sample D |
|---|---|---|
| Escorez 5415 | 52.0 | |
| Irganox B612 | 1.0 | |
| Vector 4111A | 35.5 | |
| Piccotac 1020-E | 12.5 | 11.0 |
| Kraton MD6455 | | 40.0 |
| Regalite S7125 | | 49.0 |

Adhesive tape samples were prepared as described in Example 1. The tapes were then laminated onto a nonwoven backsheet to create a sample measuring 25 mm×25 mm. The nonwoven backsheet was then clamped into an oven at 37° C. and a 1.0 kg weight attached to the tape. The time was recorded until tape and nonwoven substrate delaminated. The time for delamination of each adhesive tape from the nonwoven substrate, tack and peel strength, as measured by ASTM D1000, of each sample is depicted in Table IV:

TABLE IV

| | Time for Delamination | Tack | Peel |
|---|---|---|---|
| Sample | (minutes) | (N/25 mm) | (N/25 mm) |
| C | 1,251 | 20.9 | 7.9 |
| D | 3000 | 46.6 | 3.8 |

While the invention has been explained in relation to its preferred embodiments, it is to be understood that various modifications thereof will become apparent to those skilled in the art upon reading the specification. Therefore it is to be understood that the invention disclosed herein is intended to cover such modifications as fall within the scope of the appended claims.

What we claim is:

1. A pressure sensitive adhesive composition comprising:
from about 20% to about 60% by weight of an elastomeric component comprising a block copolymer having a thermoplastic block portion of a vinyl-substituted aromatic hydrocarbon and an elastomeric block portion of a conjugated diene;
at least about 20% of a solid tackifying resin having a Ring & Ball softening point of at least 115° C. or a glass transition temperature of at least 70° C.; and
from about 5% to about 30% of a liquid tackifying resin.

2. The composition of claim 1 wherein the block copolymer comprises one or more of styrene-butadiene, styrene-butadiene-styrene, styrene-isoprene-styrene, styrene-isoprene-buatadiene-styrene, or styrene-ethylene-butylene-styrene.

3. The composition of claim 2 wherein the block copolymer comprises styrene-isoprene-styrene.

4. The composition of claim 1 wherein the composition comprises from about 33% to about 60% by weight of an elastomeric component.

5. The composition of claim 1 wherein the solid tackifying resin comprises a hydrocarbon resin.

6. The composition of claim 5 wherein the solid tackifying resin comprises a hydrogenated hydrocarbon resin.

7. The composition of claim 5 wherein the solid tackifying resin comprises from about 25% to about 60% by weight of resin in the adhesive.

8. The composition of claim 7 wherein the solid tackifying resin comprises from about 37% to about 57% by weight of the resin in the adhesive.

9. The composition of claim 1 wherein the liquid tackifying resin is a hydrocarbon resin.

10. The composition of claim 9 wherein the liquid tackifying resin is a hydrogenated hydrocarbon resin.

11. The composition of claim 10 wherein the liquid tackifying resin is present in an amount from about 10% to about 20% by weight of the adhesive.

12. The composition of claim 1 wherein the solid tackifying resin is a mixture of a solid tackifier having a softening point of at least about 115° C. or a Tg of at least 70° C. and a solid tackifying resin having a Ring and Ball softening point of from about 75° C. to about 100° C.

13. The composition of claim 1 wherein the composition is a hot melt or solvent based adhesive composition.

14. The composition of claim 1 further comprising an antioxidant in an amount from about 0.1% to about 3% based on the total weight of the composition.

15. A pressure sensitive adhesive tape for application to a substrate, the tape having a coating of the pressure sensitive adhesive composition of claim 1.

16. The composition of claim 1 wherein the composition is applied to a substrate comprising one or more of a paper, a vinyl, a polyolefin film, a tissue, a nonwoven, a clay coated paper, a glassine, a polymer coated paper, a paperboard or a tissue.

17. A pressure sensitive adhesive tape construction comprising:
a substrate; and
an adhesive composition coated on the substrate, the adhesive composition comprising from about 20% to about 60% by weight of a block copolymer; at least about 20% of a solid tackifying resin having a Ring & Ball softening point of at least about 115° C. or a glass transition temperature of at least about 70° C.; and from about 5% to about 20% of a liquid tackifying resin.

18. The tape construction of claim 17 wherein the substrate comprises one or more of a paper, a vinyl, a polyolefin film, a tissue, a nonwoven, a clay coated paper, a glassine, a polymer coated paper, a paperboard or a tissue.

19. The tape construction of claim 17 wherein the block copolymer of the adhesive composition comprises one or more of styrene-butadiene, styrene-butadiene-styrene, styrene-isoprene-styrene, styrene-isoprene-buatadiene-styrene, or styrene-ethylene-butylene-styrene.

20. The tape construction of claim 17 wherein the solid tackifying resin comprises a hydrocarbon resin.

21. The tape construction of claim 20 wherein the solid tackifying resin comprises a hydrogenated hydrocarbon resin.

22. The tape construction of claim 21 wherein the solid tackifying resin is present in the composition in an amount of from about 25% to about 60% by weight of resin in the adhesive.

23. The tape construction of claim 17 wherein the liquid tackifying resin is a hydrocarbon resin.

24. The tape construction of claim 23 wherein the liquid tackifying resin is present in an amount from about 10% to about 20% by weight of the adhesive.

25. The tape construction of claim 17 wherein the adhesive composition is a hot melt or solvent based adhesive composition.

26. The tape construction of claim 17 wherein the adhesive composition is applied to the substrate by one or more of roller coating, curtain coating, spray coating, die coating, spraying, reverse roll coating, and/or dipping, at a coating weight of from about 15 to about 100 grams per square meter.

27. The tape construction of claim 26 wherein the adhesive composition is applied at a coating weight of from about 20 to about 50 grams per square meter.

28. The tape construction of claim 17 further comprising an antioxidant in an amount from about 0.1% to about 3% based on the total weight of the composition.

29. The tape construction of claim 17 wherein the solid tackifying resin comprises a mixture of a solid tackifying resin having a Ring & Ball softening point of at least 115° C. or a glass transition temperature of at least 70° C. and a solid tackifying resin having a Ring and Ball softening point of from about 75° C. to about 100° C.

30. The tape construction of claim 18 wherein the substrate is a polyolefin film or a nonwoven tab closure for a disposable diaper or an adult incontinent product.

31. A pressure sensitive adhesive composition comprising:
from about 33% to about 43% by weight block copolymer;
from about 37% to about 57% of a solid tackifying resin;
from about 10% to about 20% by weight of a liquid tackifying resin; and
less than about 1% antioxidant;
wherein the solid tackifying resin comprises a hydrocarbon resin having a Ring and Ball softening point of at least about 115° C. or a glass transition temperature of at least about 70° C.
